(19) United States
(12) Patent Application Publication
(10) Pub. No.: US 2006/0054205 A1
(43) Pub. Date: Mar. 16, 2006

(54) Nanobubble utilization method and device

(76) Inventors: Akira Yabe, Ibaraki (JP); Mizuki Goto, Ibaraki (JP)

Correspondence Address: MORGAN LEWIS & BOCKIUS LLP, 1111 PENNSYLVANIA AVENUE NW, WASHINGTON, DC, 20004, US

(21) Appl. No.: 10/530,047

(22) PCT Filed: Sep. 30, 2003
(86) PCT No.: PCT/JP03/12523

§ 371 Date: Apr. 1, 2005

(30) Foreign Application Priority Data
Oct. 1, 2002 (JP) 2002-288963

(51) Int. Cl. B08B 3/12; B08B 6/00

(52) U.S. Cl. 134/184; 134/1

(57) ABSTRACT

The present inventors have found the presence of a nanobubble that has not been confirmed conventionally, and established a method for producing nanobubbles. The inventors have determined the theoretically expected characteristics of the produced nanobubbles, found new characteristics by analyzing data experimentally collected, and elucidated the relationship among the characters. Specifically, the inventors have found that a nanobubble has features such as decrease of the buoyant force, increase of the surface area, increase of the surface activity, generation of a local high-pressure field, interface activating action, and sterilizing action thanks to electrostatic polarization. By the association among the features, any of wide variety of objects can be cleaned with high performance and with light environmental load thanks to the function of adsorbing foul components, the function of cleaning the surface of an object quickly, and the sterilizing function, and polluted water can be purified. Nanobubbles can be applied to an organism to recover from fatigue and effectively used for chemical reactions.

### TECHNICAL FIELD

The present invention relates to a nanobubble-utilizing method and apparatus for effectively utilizing nanobubbles in various fields by utilizing characteristics of bubbles having a diameter of nanometer-order, such as increase of surface areas, generation of a high pressure, realization of electrostatic polarization, increase of surface activity, and decrease of a buoyant force.

### BACKGROUND ART

Conventionally, various investigations have been made as to microbubbles having a diameter of micrometer-order. That is, bubbles having a diameter of about 10 microns are generated by cavitation. Then, it have been considered and partially used that the microbubbles are used for environment protection by utilizing the function of the microbubbles such as air-liquid dissolution and floatation or by utilizing the function of cleaning water polluted by oil and the like, or are used for promoting the growth of water-borne animals and plants by utilizing the growth promotion effects and the like in culture and the like.

In order to enhance such functions of the microbubbles, it is naturally considered to make the sizes of the bubbles smaller and utilization of nanobubbles having a diameter of nanometer-order has been considered as small-sized bubbles.

However, in the conventional technique, there has been no method for confirming the presence of such bubbles having a diameter of nanometer-order, that is, nanobubbles. Thus, it has not been confirmed even as to whether nitrogen or oxygen dissolved within water is present in a state of molecules or in a state of bubbles with a nanometer-order size. Also, there is no apparatus for generating nanobubbles, and it has not been confirmed even as to whether or not nanobubbles can be generated by the conventional cavitation.

Supposing that there are nanobubbles, it is considered that there are nanobubbles of single-component system such as bubble of vapor existing within water, for example, and nanobubbles of multi-component system consisting of gas, such as nitrogen or oxygen, as air dissolved in water. Since a small-sized babble having an inner pressure equal to or larger than the pressure of the bubble of the existing bubbles cannot exist, it is necessary to provide an environment where about 100 atmospheric pressure (atms) can be realized. Although the presence of such nanobubbles is supposed by such observation that an air-liquid interface surface is present at the water confined within a carbon nanotube, this is mere speculation. Also, it is known that bubbles disappear at the time of the cavitation or subcooled boiling, and it is predicted bubble with a diameter of nanometer-order is present transitionally on the way of the disappearing process of the bubbles. Furthermore, as described above, the nanobubbles of multi-component system is present in the case where air, nitrogen, oxygen or carbon dioxide is dissolved in water and is present as bubbles. As the nanobubbles of multi-component system, microbubbles having a diameter of about 1 micron was observed but bubbles having a diameter of nanometer-order less than 1 micron have not been confirmed yet.

Thus, since it has not been confirmed that the nanobubbles are present within water, the existence of the nanobubbles is mere speculation. Even if it is supposed that the nanobubbles are present, it has not been solved whether or not the characteristics of the nanobubbles are extended from those of the microbubbles and whether or not the nanobubbles has other characteristics. Also, a method for generating the nanobubbles is merely beyond the compass of imagination. Furthermore, effectively utilization of the nanobubbles has been merely an armchair plan in accordance with speculation extended from the characteristics of the conventional microbubbles.

In order to solve such current problems, as a result that the inventors of the present invention have earnestly investigated, they confirmed that there exists the nanobubbles and developed an apparatus for generating the nanobubbles which was filed as a patent application entitled “Apparatus for Generating Nanobubbles” (Japanese Patent Application No. 2002-145325). Since the technique is described in detail in specification of the patent application, the detailed explanation thereof is omitted but the technique was realized by utilizing an apparatus schematically shown in FIG. 5.

In FIG. 5, a testing room 1 is a room for performing electrolysis of water and for generating nanobubbles by the action of an ultrasonic wave generating device 2 disposed at the lower portion of the testing room. The testing room is configured by a rectangular pipe made of stainless steel and is provided with glass windows at the two side walls thereof so that a person can observe the inner state thereof. The test room has a length of 40 mm, a width of 40 mm and a height of 270 mm which is several times (10 times) of a half wave length (27 mm) of the wave being generated so that a standing wave is generated, as described later. A top plate made of stainless steel having a discharge port for discharging a liquid containing bubbles is disposed at the upper end of the rectangular pipe, and a bottom plate made of stainless steel attached at the rear surface thereof with the ultrasonic wave generating device 2 having a vibration plate is disposed at the lower end of the rectangular pipe.

The ultrasonic wave generating device (SC-100-28 manufactured by STM Co.) has an oscillator made of ferrite having a frequency of 28 kHz. The output of the oscillator is transmitted to the vibration plate to generate an ultrasonic wave within the test room. An anode for electrolysis is attached at the bottom plate of the test room 1, and a cathode is attached within a pipe for discharging hydrogen which is connected with the rectangular pipe. A power supply device for electrolysis (4329A High Resistance Meter manufactured by Yokogawa Hewlett Packard Co.) is used which has a large resistance value and is capable of flowing a small amount of current when applied with a voltage of a predetermined constant value.

Distilled water supplied from a distilled water supply pipe 6 is converted into ultra-pure water by an ultra-pure water manufacturing device 5 (Milli-Q Synthesis manufactured by Millipore Co.) and the ultra-pure water is supplied through an ultra-pure water pipe 7 provided at the lower end of the test room 1. Within the test room 1, the ultra-pure water is electrolyzed so that oxygen is generated from the anode on the surface of the bottom plate, whereby the oxygen thus generated is discharged outside from the water as bubbles by the action of the ultrasonic wave. In this case, nanobubbles are partially generated. Even only by applying ultrasonic wave without performing the electrolysis, non-visible cavitation is generated by the pressure change to thereby generate nanobubbles.

A bubble pipe 8 is provided at the upper portion of the test room 1 so that the bubbles generated in the test room flow into a particle counter 4 through the bubble pipe, whereby the particle counter counts the bubbles generated in the above-described manner. The particle counter 4 has a first particle counter (KS16 manufactured by Rion Co.) for counting particles having a diameter of 100 nm or less and a second counter (KS17 manufactured by Rion Co.) for counting particles having a diameter of 100 nm or more. Each of the particle counters employs a semiconductor laser for irradiating a laser light with a wavelength of about 830 nm as a light source and receives the laser light by a photo diode. The bubbles can circulate in such a manner that the bubbles pass the particle counter 4 and return to the ultra-pure water manufacturing device 5.

The above-described particle counter is arranged in such a manner that the light is irradiated from the semiconductor laser into the test cell within a measuring device, and the change of the intensity of scattered light emitted from bubbles or fine particles passing through the laser light is read to measure diameters of the bubbles or fine particles. In this range, the bubbles (or particles) can be recognized as spherical. Also, since the diameter of the bubble (or particle) is almost same as the wavelength, the relationship between the scattered light intensity I_{θ} and the diameter d of a bubble can be solved by using a simultaneous equation based on the Mie scattering theory.

The conventional distilled and ion exchanged water includes about one hundred thousand fine particles (or fine bubbles) with a diameter of 500 nm or more per ml, so that it cannot be distinguished between the fine particles and the fine bubbles. Thus, at the time of operating the above-described apparatus, an experimental apparatus for the flowing characteristics of the air-liquid interface of the microbubbles is improved, and the nanobubbles are generated in a state where the ultra-pure water manufacturing device is operated continuously and the number of the fine particles is reduced to about several per ml. As a result, according to an experiment described later, it could be confirmed that nanobubbles are generated within water and exist normally.

First, water is circulated between the ultra-pure water manufacturing device and the water within the test portion is purified until the number of the particle counter is stabilized. After the number of the particle counter becomes almost constant, an ultrasonic wave is generated by the ultrasonic wave generating device and bubbles generated is measured by the particle counter. The measurement of the bubbles is carried out while monitoring the water temperature, a total organic carbon (TOC) amount of supplied water and the water after passing through the test portion, the number of ultra-fine particles, the number of bubbles and the output current of the ultrasonic wave generating device. In this case, the oxygen density γ within the water (that is, a ratio of the density of oxygen within the water with respect to saturation density thereof of one atm) is 2.0, and the ultrasonic wave has a wavelength of 28 kHz and an output power of 100 W.

As a result, the experimental results were obtained as shown in FIG. 6. This figure shows a graph representing the densities (number/ml) for each group of the diameter ranges of the bubbles. That is, this figure shows, as to each group of the diameter rangs, (a) the density before the application of the ultrasonic-wave vibration, (b) the density during the application of the ultrasonic-wave vibration, (c) the density after the application of the ultrasonic-wave vibration, and (b-a) the difference between before the application of the ultrasonic-wave vibration and the density after the application of the ultrasonic-wave vibration for representing the change of the density of the bubbles due to the application of the ultrasonic-wave vibration.

According to this experimentation, it was confirmed that there were bubbles having a diameter of at least a nm-order, that is, nanobubbles within the water, and further confirmed that there were also nanobubbles having a diameter of about 50 nm at a high density. Furthermore, particularly, it was confirmed that nanobubbles were surely generated when the ultrasonic-wave vibration was applied and were existed normally by applying the ultrasonic-wave vibration.

Also, from FIG. 6, it is understood that nanobubbles of all the sizes were generated when the ultrasonic-wave vibration was applied, and that the smaller the diameter of the bubble was, the larger the density (number/ml) of the bubble was. Furthermore, as is clear from a graph shown in FIG. 7 which represents only the difference (b-a) in FIG. 6, the smaller the diameter of the nanobubbles generated by the ultrasonic-wave vibration was, the larger the density (number/ml) of the bubble was. Although the smaller the diameter of the nanobubbles was, the larger the number of the bubbles was, the volume of the bubble is proportional to the cube of the diameter of the bubble. Thus, when the mean value of the volume is multiplied at each group of the diameter ranges of the bubbles, it was found that the rate of the volume became larger as the diameter of the bubble was large.

The utilizing techniques are disclosed in the following documents.
Patent document 1: JP-A-2002-119
Patent document 2: JU-A-4-21381
Patent document 3: JU-A-55-180425

### DISCLOSURE OF THE INVENTION

As described above, the inventors of the present application have confirmed that there exists the nanobubbles and filed the patent application. As disclosed in the patent application and briefly described above, it was found that nanobubbles could be surely generated by performing the electrolysis and applying the ultrasonic-wave vibration. Thus, it became a real problem to consider the effective utilization of the above-described nanobubbles. Therefore, the inventors of the present application have elucidated the characteristics of such nanobubbles, investigated effective usages utilizing such characteristics, and repeated experimentations.

Therefore, an object of the present invention is to provide a nanobubble-utilizing method and apparatus for effectively utilizing nanobubbles of which existence was clarified and generation apparatus was established by the inventors of the present application.

The inventors of the present application elucidated the characteristics of the above-described nanobubbles and found the following matters. That is, the nanobubble with a diameter of about 50 nm to 100 nm has a pressure of about several tens atms due to the surface tension within water and can generate an air jet when the bubble collapses, whereby the cleaning effect for the surfaces of an object can be expected. Also, since the surface activity of the bubble is high and foil components can be adsorbed to the interface, the foul component of water can be effectively removed. In particular, the bubble of an about 100 nm diameter has a surface area about several ten thousands times as large as that of a bubble of about several mm diameter usually observed for the same volume, and the bubble of an about 100 nm diameter is expected to have a high cleaning speed. Also, according to the calculation result of the molecular dynamics for air bubbles having a nanometer order size within the water, it is expected that the hydrogen bonds of the water interact with one another and the probability where hydrogen atoms exist within the bubble is large. Thus, it was proved that when such mutual action of molecules is exerted, the charge separation similar to soap can be realized at the air-liquid interface due to the bubbles having a nanometer-order size, whereby the cleaning promotion effects and the electrostatic sterilizing effects can be expected.

By utilizing the above-described characteristics of the nanobubbles, the nanobubbles are applied to the cleaning method and apparatus utilizing nanobubbles as an embodiment of the method and apparatus for utilizing nanobubbles of the present invention, and objects are cleaned by using the water comprising nanobubbles. In this respect, although it has been considered to clean objects by utilizing air bubbles having a relatively small diameter, since the existence of the nanobubbles themselves could not be confirmed, it was an armchair plan to clean various kinds of objects by the water comprising nanobubbles, that is, to actually clean various kinds of objects by the conventional nanobubbles. The inventors of the present application proved the existence of the nanobubbles and established the method and apparatus for generating the nanobubbles. As a result, the nanobubbles can be actually utilized for the cleaning method and apparatus. Also, the characteristics of the nanobubbles was confirmed by actually generating the nanobubbles. In particular, the inventors of the present application have invented the present invention by finding new characteristics such as the electrolytic separation phenomenon on the surface of the nanobubble.

As another embodiment in which the cleaning method and apparatus utilizing nanobubbles according to the present invention are realized more concretely, there is one in which nanotechnology-associated equipments are cleaned by the ultra-pure water at the time of cleaning objects by the water comprising nanobubbles. Also, industrial equipments are cleaned by the water comprising nanobubbles and an organism is cleaned by the water comprising nanobubbles. The water to be used is electrolyzed water, ionized alkaline water or acid water. When the microbubbles are imparted to the water comprising nanobubbles, the function of the nanobubbles can be further improved.

Also, since the surface activity of the bubbles is high in the nanobubbles as described above, foul components can be absorbed to the interface, so that the nanobubbles are effective for removing foul components in water. Also, still another embodiment of the method and apparatus for utilizing the nanobubbles according to the present invention is arranged to utilize the nanobubbles so as to absorb polluted material by utilizing such characteristics that the nanobubbles have a quite large surface area per volume. Also, microbubbles are mixed to the water so that the nanobubbles having absorbed the polluted material in this manner move upward within the water.

Furthermore, as described above, since the nanobubble generates an air jet of about several tens atms when the bubble collapses, still another embodiment of the method and apparatus for utilizing the nanobubbles according to the present invention is arranged to utilize the nanobubbles so as to recover fatigue of an organism by contacting the water comprising nanobubbles to the organism skin. In this case, microbubbles are also mixed to the water so that the organism contacts with the microbubbles within a bathtub.

Also, since the nanobubble has a quite large surface area per volume, another example of the method and apparatus for utilizing the nanobubbles is arranged by utilizing the characteristics that the chemical reaction can be changed, so that the nanobubbles can be effectively utilized for various kinds of the chemical reactions. In this case, the mechanical reaction is utilized particularly for the non-equilibrium chemical reaction and the nanobubbles act as a catalyst.

Also, the above-described nanobubbles are utilized so as to be made in contact with plants, particularly, vegetables, fruits, crops, foods and the like to clean and sterilize them and are also utilized to purify the water within a pool or a water tank. Furthermore, the above-described nanobubbles are generated stably at least by application of an ultrasonic wave to water or by electrolysis. In this case, of course, the application of an ultrasonic wave and the electrolysis can be combined.

### BRIEF DESCRIPTION OF THE DRAWINGS

FIG. 1 is a diagram for explaining a utilizing field system which shows the mutual relationship of the function, action, effects and the utilizing fields of the nanobubble utilizing technique according to the present invention.

FIG. 2 is a diagram showing a state of electrostatic polarization caused on the surface of the nanobubble.

FIG. 3 is a diagram for explaining a state where the microbubble is converted in a solid fine particle after the adsorption of fine particles on the surface of the nanobubble.

FIG. 4 shows experimental data investigated as to the relationship between Reynolds numbers and resistance coefficients of solid fine particles and liquidity boundary surface sphere.

FIG. 5 is a schematic diagram showing an experimental apparatus by which inventors of the present application generated nanobubbles within pure water and observed the nanobubbles.

FIG. 6 is a graph showing the densities of the microbubbles before and during the operation of an ultrasonic-wave vibrator, obtained by the experimental apparatus.

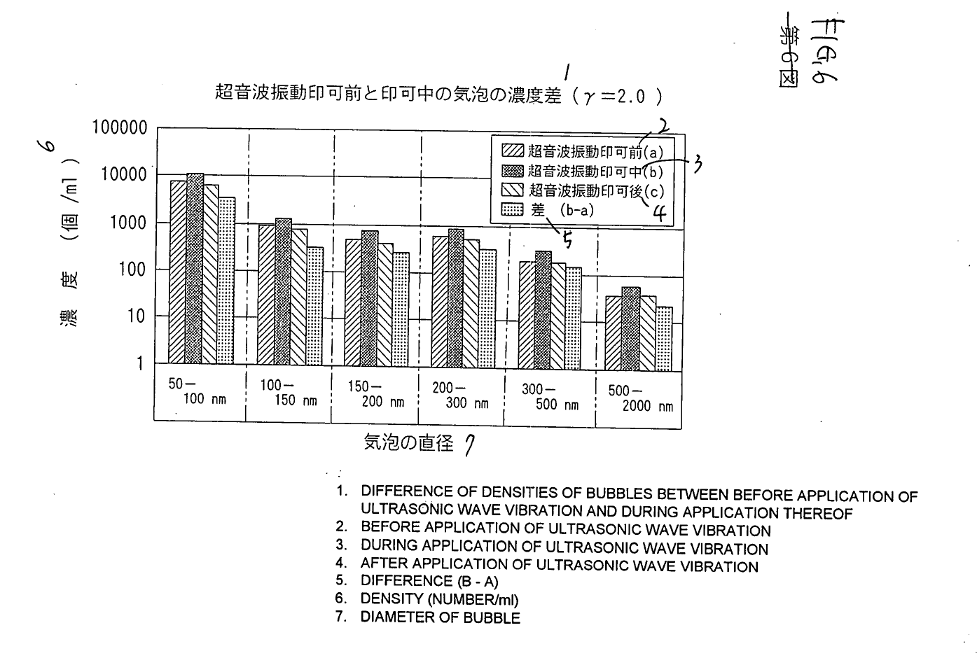

FIG. 7 is a graph showing the generation state of the nanobubbles, which is taken as to only the density difference portions of the graph in FIG. 6. A diagram for schematically explaining a transistor.

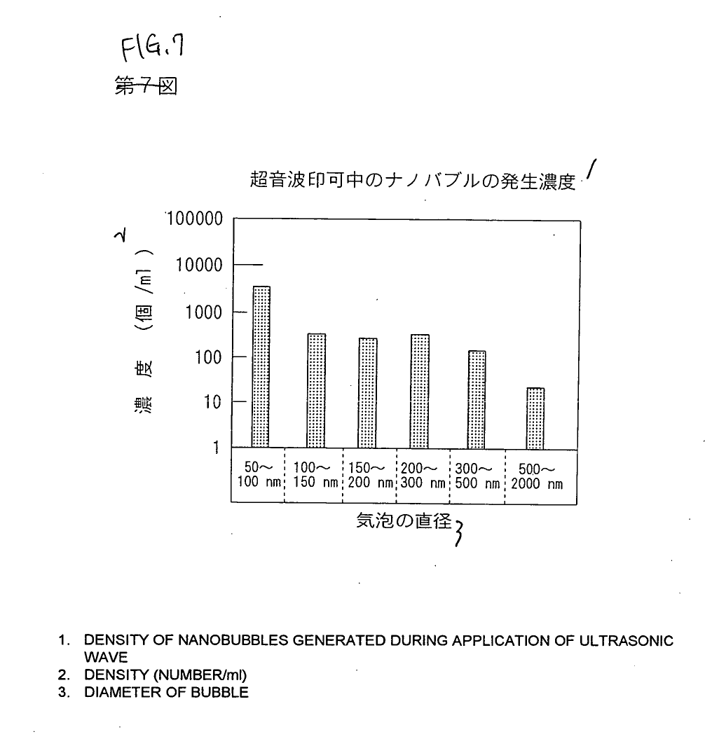

### BEST MODE FOR CARRYING OUT THE INVENTION

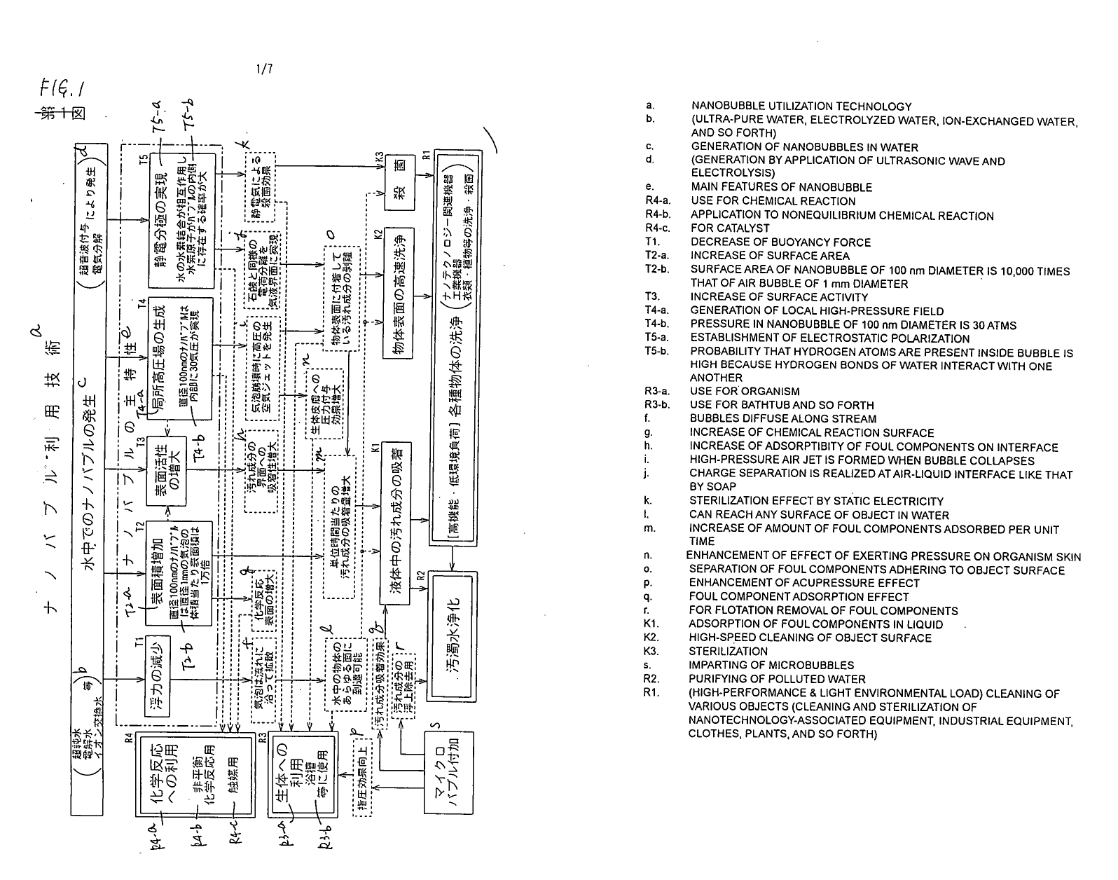

As has been already disclosed in the above-described patent application, the inventors of the present application clarified the technique for surely generating the nanobubbles by the electrolysis or the application of an ultrasonic wave. Thus, the inventors of the present application have thought how to effectively utilize the nanobubbles and elucidated the characteristics of the nanobubbles, the results of which is shown in FIG. 1.

As is clear from FIG. 1, the nanobubbles can be generated by the application of an ultrasonic wave or the electrolysis in not only normal water but also ultra-pure water, electrolyzed water, or alkaline water or acid water using ion-exchanged water. The nanobubbles thus generated have major characteristics shown by T1 to T5 in the figure.

As is shown in FIG. 1, the nanobubble has a particularly remarkable characteristics in increase of the surface area (T2). In this respect, according to the conventional investigation in the microbubbles, it was theoretically predicted that, when there exist nanobubbles, the surface area of the micro bubble increases to further improve the characteristics of the microbubble. However, it was uncertain whether or not there exist the nanobubbles actually. Then, the inventors of the present application elucidated for the first time the existence of the nanobubbles and established the mean for generating the nanobubbles. Thus, instead of the conventional supposed discussion, according to the predicted theory that the nanobubbles exist actually, by comparing a nanobubble having a diameter of 100 nm with a bubble having a diameter of 1 mm, the existence of the bubble having characteristics in which the surface area per volume (specific surface area) is 10,000 times higher was confirmed.

According to such characteristics, the ability of the bubble for absorbing materials on the surface thereof can be increased remarkably and an amount of foul components adsorbed per unit time can be increased. Also, foul components in a liquid can be adsorbed at a high speed (K1), the nanobubbles can be utilized for cleaning various kinds of objects (R1), and the nanobubbles can be utilized effectively for purifying polluted water. Also, since the surface area of the bubble increases remarkably, the chemical reaction surface can be increased in the chemical reaction using the surface as the reaction surface, so that the nanobubbles can be utilized effectively in the field of the chemical reaction (R4).

Also, the nanobubble is remarkable in its generation characteristics (T4) of the local high-pressure field. In the conventional investigation of the microbubbles, the characteristics of the microbubbles were predicted in the case of supposing that the nanobubble is present. However, as described above, since the existence of the nanobubble was confirmed and the means for generating the nanobubbles were established, a pressure Δp within the bubble within the water becomes 30 atms as to the nanobubble of a 100 nm diameter in accordance with a relationship among the pressure Δp within the bubble within the water, the surface tension σ of the bubble and the diameter of the bubble [Δd=2 σ/d]. In this manner, it was confirmed that there existed the bubble which has the characteristics of capable of realizing the local high-pressure of 30 atms within the bubble.

According to the characteristics, when the nanobubble collides with an object and collapses, the high-pressure air within the bubble is erupted to generate an air jet. Thus, the foul components adhered to the surface of the object can be surely separated therefrom, so that the high-speed cleaning of the object surface can be realized (K2). Thus, the nanobubble is suitable for cleaning various kinds of objects (R1). Also, the nanobubble may be utilized effectively in the chemical reaction by utilizing the local high-pressure state (R4). Furthermore, when the air jet is applied to an organism by using it for the water within a bathtub and the like, the effects of applying a pressure to the skin of the organism such as a human body is enhanced, so that the fatigue recovering effects due to the acupressure effects of chiropractic is improved. Also, as described above, the bubble exerts the effect of separating foul components adhered to the skin surface, the nanobubble is effective when applied to organism (R3).

Also, the surface of the nanobubble relates to the increase of the surface area per volume (T2) and the generation of the local high-pressure field (T4), which results in the increase of the activity of the surface thereof (T3) to thereby increase the adsorptibity of foul components on the interface. As a result, as described above, in addition to the increase of the amount of foul components adsorbed per unit time due to the increase of the surface area per unit volume, the effects of the adsorptibity can be further enhanced. Thus, the adsorption function of foul component within a liquid can be enhanced (K1) and the cleaning ability for various kinds of equipments can be improved (R1). Also, the nanobubble is effective for purifying polluted water (R2).

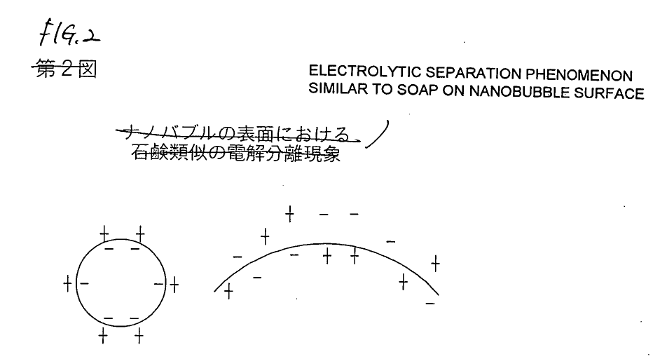

Furthermore, the nanobubble has a unique characteristics that the electrostatic polarization can be realized (T5). That is, as shown in FIG. 2, since the hydrogen bonds interact with one another, the electrostatic polarization occurs in time-average, and the probability where the hydrogen atoms are present inside the bubble becomes high. Thus, it is possible to theoretically know the characteristics of the bubble through the calculation based on the molecular dynamics.

According to the characteristics, the charge separation similar to the conventional soap can be realized at the air-liquid interface. The charge separation acts to separate the foul component adhered to the object surface, whereby the separation effect of an object can be synergistically enhanced together with the physical separation effect of the air jet. Thus, the high-speed cleaning of the object surface is made possible (K2) and the characteristics can be effectively utilized for the cleaning and sterilization of various kinds of objects (R1). Also, when the separation effects of the foul components adhered to the object surface is applied to an organism (R3), the skins of patients which cannot be washed with soap due to various kinds of sick can be cleaned. Furthermore, even in the case where the surface active agent can be used, the characteristics is effective for a person who is required to immediately and entirely wash off the agent. Furthermore, the nanobubbles may be utilized for chemical reactions by using the electrostatic polarization (R4).

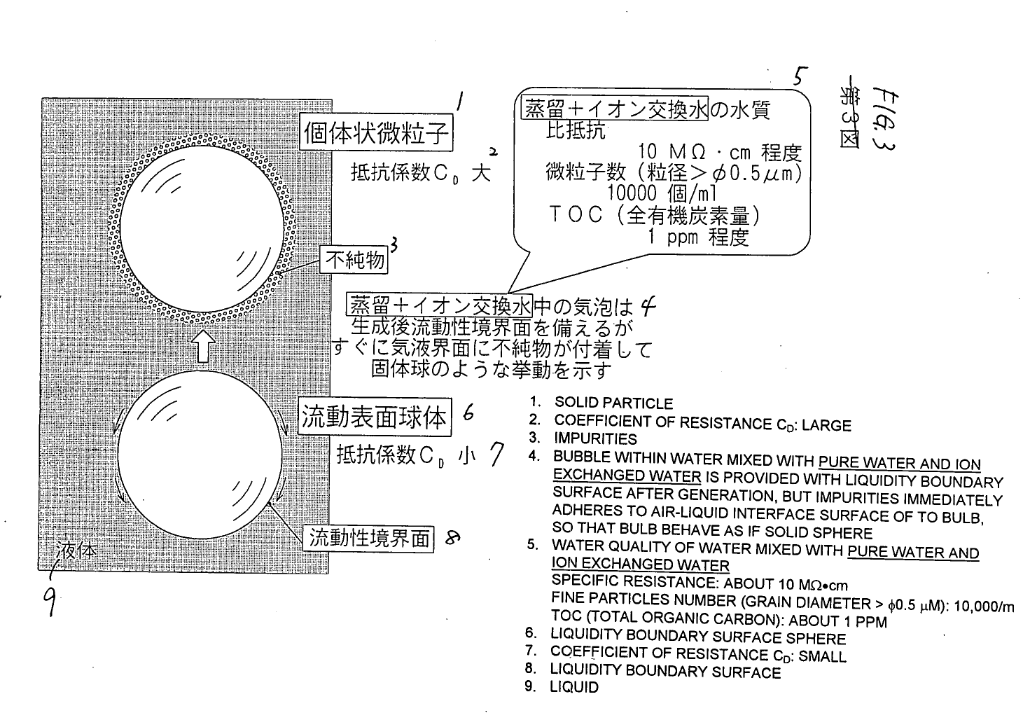

Consideration will be made as to a state where foul components are adhered to the above-described nanobubbles. For example, as is shown in FIG. 3, when the nanobubbles are generated by applying the above-described ultrasonic wave and the like within the water mixed with pure water and ion exchanged water in which about 10,000 fine particles having a specific resistance of 10 MΩ cm and a grain diameter of 0.5 μm or more are present per unit ml and about 1 ppm of TOC (total organic carbon) is present, at first, the bubble has a liquidity boundary surface on the surface thereof to form a liquidity boundary surface sphere, and the coefficient of resistance CD is small. However, impurities immediately adheres to the air-liquid interface surface of the nanobubble and the nanobubble becomes similar to a solid fine particle having a large coefficient of resistance CD.

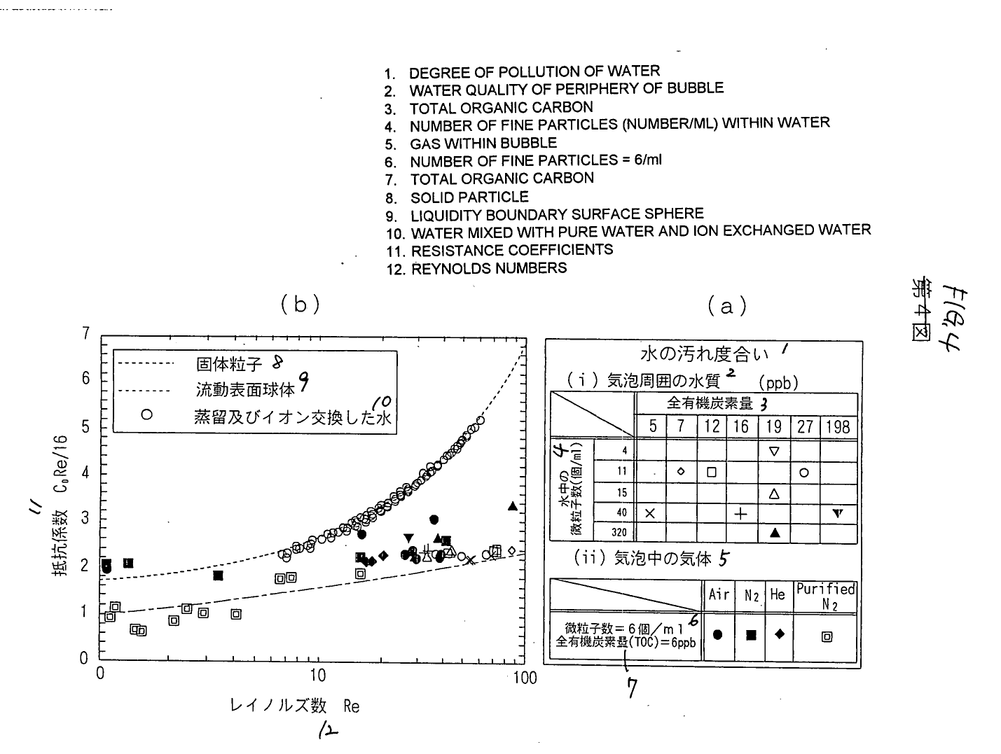

As is shown in the experimental result shown in FIG. 4, the resistance coefficients of the liquidity boundary surface sphere with respect to the respective Reynolds numbers in a state where the nanobubbles of a micrometer-order diameter have just been generated is shown by a lower side graph in the FIG. 4(b). In contrast, the microbubble having been converted into the solid fine particle state increases its resistance coefficients as shown by a lower side graph in the figure, as is clear from the graph showing the case of the water mixed with pure water and ion exchanged water. According to the above-described increase of the resistance coefficients in addition to that the nanobubble converted into the fine particles state has a characteristics of reduced buoyancy, the nanobubbles converted into the fine particles state can hardly move within the liquid and merely float within the liquid.

As described above, it is clear that the peripheral impurities immediately adheres to the nanobubble having been generated within the water. Thus, the nanobubbles are effective at the time of cleaning various objects and also at the time of purifying the polluted water containing fine particles and organic substance.

In this manner, since the nanobubbles realize the charge separation at the air-liquid interface similarly to soap and also have not only the function of separating the foul components adhered to the object surface but also the function of adsorbing the impurities after being separated, this technique can be applied in place of detergents having been utilized in the wide fields. Thus, if 10% of the consumed quantity of detergents is replaced by this technique in Japan, the replaced energy corresponds to one million barrels of oil according to another calculation which also corresponds to an amount of energy of one day consumed in Japan. Therefore, this technique is very important for Japan as well as other countries.

When comparing the power consumed at the time of using a washing machine with the power consumed as the driving energy of an ultrasonic wave vibrator for attaining the cleaning effects which is considered to be surely realized by further investigating and developing hereinafter, it is predicted that an amount of consumed energy for attaining the same cleaning effects is quite smaller in the latter case than the former case. In this manner, this invention is considered to be the cleaning technique of a light environmental load since the present invention is effective in the reduction of carbon dioxide gas due to the reduction of a consumed amount of oil resulted from non-use of detergents and the reduction of the driving energy.

Also, according to the realization of the electrostatic polarization (T5), the sterilization effect can be attained by the static electricity thus generated. Thus, particularly, the electrostatic polarization can be effectively used when it is necessary to sterilize the surface of an object to be cleaning (K3) at the time of cleaning various kinds of equipments (R1). Also, the electrostatic polarization can be used for the cleaning and sterilization by contacting the nanobubbles to plants, particularly vegetables, fruits, crops, foods and the like. Also, the electrostatic polarization can be used for an organism (R3) to thereby effectively apply the nanobubbles to a patient whose skin is required to be sterilized as well as a normal person. Incidentally, the characteristics of the electrostatic polarization is considered to be effectively applied to the chemical reaction according to the necessity. Although the description is omitted since the drawings seem to become complicated, of course, the sterilization action is effective also for the cleaning of polluted water and can be used for the purification and sterilization of water within a pool or a water tank.

The buoyancy force of the nanobubble reduces remarkably (T1) and becomes almost zero, so that the bubbles diffuse along the flow and can reach every surfaces of objects within water. Thus, since the bubbles enter into fine spaces within the objects to exert the function (K1) of improving the adsorption action of foul components within liquid due to the increase of an amount of the foul components adsorbed per unit time as described above, the high-speed cleaning function of the object surface (K2) and the sterilization function (K3), the cleaning function (R1) of the various kinds of equipments can be enhanced. In this manner, the cleaning of various objects can be performed with a high performance.

Also, when the nanobubbles are used for an organism, they can be spread to fine portions of the human body for the acupressure effects by the above-described air jet, the separation action by a high-pressure caused by the air jet, and the effects similar to that of soap and the sterilization effect by the electrostatic polarization and the like. Incidentally, at the time of utilizing the nanobubbles for an organism, if the organism is an animal such as a fish, it is considered that nanobubbles can be applied similar to conventional applications of nanobables to the fish firming, the keeping of flesh fishes, and the like. In this case, due to the decrease of the buoyancy force of the nanobubbles (T1), the nanobubbles supplied within the water can be effectively applied to fishes and the like without losing the nanobubbles from the surface side of the water.

Summarizing the above-described matters, due to the main characteristics of the nanobubbles of the decrease of the buoyancy force (T1), the increase of the surface area (T2), the increase of the surface activity (T3), the generation of the local high-pressure field (T4) and the establishment of the electrostatic polarization (T5), the nanobubbles generated by the application of an ultrasonic wave or the electrolysis within water such as ultra-pure water, electrolyzed water or ion-exchanged water can clean various objects such as nanotechnology-associated equipments, industrial equipments and clothes with the light environmental load with a high performance and without using soap or the like (R1) by the adsorption function of foul components in liquid (K1), the high-speed cleaning function of the object surface (K2), the sterilization function (K3) and the like. Also, polluted water generated in wide fields as well as polluted water containing foul components separated within water in this manner can be effectively purified (R2) by the adsorption function of foul components in liquid, particularly. Furthermore, the various effects can be obtained for an organism such as sterilization, removal of foul components adhered to the object surface by the air jet or soap effects, and acupressure effects by the air jet (R3). Furthermore, the nanobubbles can be effectively utilized for chemical reactions due to the generation of a local high-pressure field, the establishment of an electrostatic polarization and the increase of the chemical reaction surface (R4).

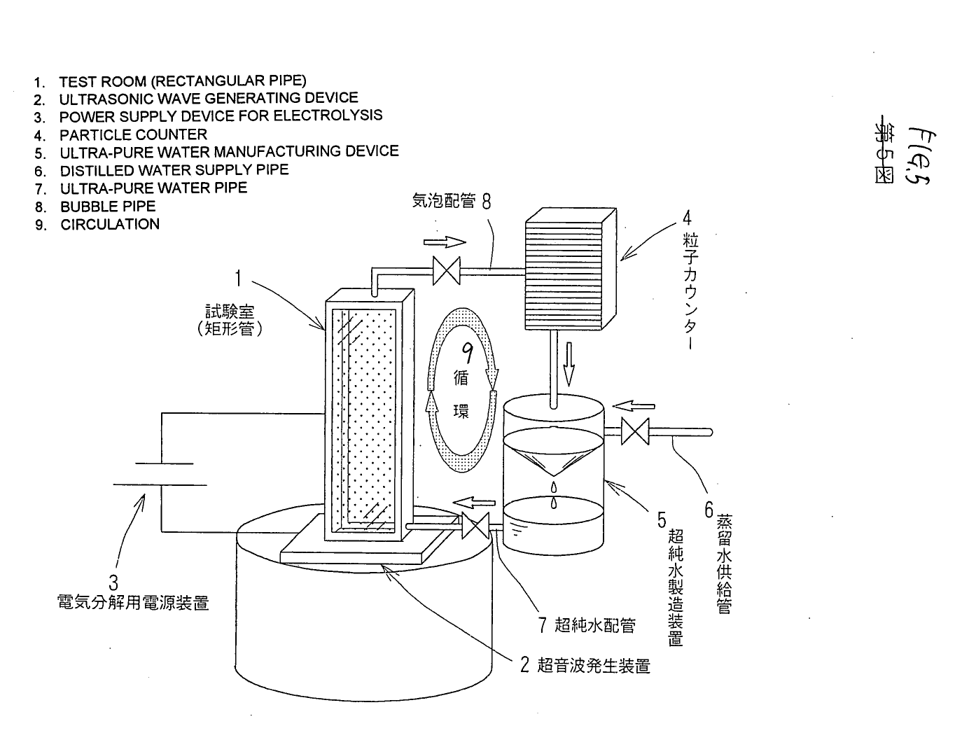

In the case where the conventionally known microbubbles are imparted to the water where the above-described nanobubbles are present, when foul components adheres to the microbubble, the microbubble is converted into the solid fine particle state as described above, whereby the resistance coefficients thereof increases. Also, since the nanobubble has a small degree of buoyancy originally, the nanobubbles scarcely move upward in the liquid surface direction and merely float within the liquid. However, the microbubbles thus imparted adsorb the fine particles of the nanobubbles onto the surface thereof, whereby the microbubbles move upward due to the buoyancy thereof within the liquid and can be gathered on the surface of the liquid. Thus, the polluted water can be purified more effectively (R2). The thus gathered nanobubbles which adsorb the foul components and are converted into the fine particle state can be easily removed by being scooped up on the surface of the liquid. Incidentally, in the case of not imparting any microbubbles or evening in the case of imparting the microbubbles in the above-described manner, the nanobubbles can be exhausted outside of the apparatus by providing a separation means such as a filter at the pure water manufacturing portion in the experimental apparatus shown in FIG. 5.

Also, when the microbubbles are imparted, even in the case where there are relatively large impurities which can be hardly removed by the microbubbles at the time of adsorbing foul components, the impurities can be effectively adsorbed and removed by the microbubbles like the conventional removing method for polluted water using the microbubbles. Thus, the adsorption function of foul components in liquid (K1) can be enhanced furthermore. Also, when the microbubbles are mixed into a bathtub or the like in which the nanobubbles are supplied in the above-described manner, the conventional acupressure effects can be added due to the collapse of the relatively large bubbles, whereby the bubbles can be utilized more effectively.

In particular, the techniques of cleaning various objects and purifying polluted water using the nanobubbles according to the present invention are expected to apply a large impact to wide industrial fields hereinafter. As to the cleaning technique, the techniques are largely expected particularly in the technical field relating to nanotechnology such as cleaning of semiconductor devices. In such a technical field relating to nanotechnology, it is preferable to use pure water in which the nanobubbles are generated.

Also, the technology of the present invention can be used instead of conventional detergents in the field of the washing including normal families. When this technology is utilized widely, detergents per se and most of energy required for manufacturing detergents can be reduced. Also, in a view point of the energy efficiency of the ultrasonic wave vibrator, most of the driving power for the washing machine can be removed. In view of these matters, the environmental load can be made small.

In the field of cleaning polluted water in which the development of technique more effective than the current technique has been desired, fine particles containing an organic substance can be removed surely by using the ultrasonic-wave vibrator which can generate the nanobubbles effectively or by also using the conventional microbubble generating device. Also, the microbubble is arranged to adsorb the nanobubble which adsorbs fine particles and the like and thus converted into a solid fine article, whereby the microbubbles can move up on the liquid surface.

According to the present invention, as described above, although it was expected that the nanobubbles exist actually but the existence thereof has not been confirmed yet, the inventors of the present application have clarified that the nanobubbles are present actually and further established the manufacturing method for the nanobubbles. Also, the inventors of the present application have determined the characteristics of the nanobubbles being predicted theoretically, then analyzed the data obtained from the experimentation to discover new characteristics and elucidated the mutual relationship of these characteristics, and then specified the fields in which the nanobubbles can be utilized effectively. One of the utilization modes thus specified is the cleaning of objects.

Concerning the cleaning of objects, by utilizing all of the functions of the nanobubble, that is, the reduction of the buoyancy, the increase of the surface area, the increase of the surface activity, the generation of the local high-pressure field, the interface activation effect similar to soap by the establishment of the electrostatic polarization and the sterilization effect by the static electricity are effectively used, objects can be cleaned quite effectively by the mutual action thereof and the multiple effects thereof. Also, the nanobubble can also be utilized effectively at the time of purifying polluted water.

Similarly, when the nanobubbles are utilized for the recovery of fatigue of an organism, the fatigue of an organism can be effectively recovered by the above-described various functions and actions of the nanobubbles. Furthermore, the nanobubbles can be effectively utilized for chemical reactions by the above-described various functions and actions of the nanobubbles.

### INDUSTRIAL APPLICABILITY

As is also shown in FIG. 1, the utilization technology of the nanobubbles according to the present invention can be utilized for cleaning and sterilization of nanotechnology-associated equipments, industrial equipments, clothes, plants, foods and the like, and also can be utilized for purification of polluted water, for an organism within a bathtub or the like and further for various chemical reactions.

1. A cleaning method utilizing nanobubbles, which comprises cleaning an object with water comprising nanobubbles.

2. The cleaning method utilizing nanobubbles according to claim 1, wherein the water is ultra-pure water and the object is a nanotechnology-associated equipment.

3. The cleaning method utilizing nanobubbles according to claim 1, wherein the object is an industrial equipment.

4. The cleaning method utilizing nanobubbles according to claim 1, wherein the object is an organism.

5. The cleaning method utilizing nanobubbles according to claim 3, wherein the water comprising nanobubbles is electrolyzed water, ionized alkaline water or acid water.

6. The cleaning method utilizing nanobubbles according to claim 1, wherein the water comprising nanobubbles further comprises microbubbles.

7. A cleaning apparatus utilizing nanobubbles, which comprises:
a device for generating nanobubbles within water; and
a water supply device for supplying water comprising nanobubbles to an object to be cleaned.

8. The cleaning apparatus utilizing nanobubbles according to claim 7, wherein the water is ultra-pure water and the object is a nanotechnology-associated equipment.

9. The cleaning apparatus utilizing nanobubbles according to claim 7, wherein the object is an industrial equipment.

10. The cleaning apparatus utilizing nanobubbles according to claim 7, wherein the object is an organism.

11. The cleaning apparatus utilizing nanobubbles according to claim 9, wherein the water comprising nanobubbles is electrolyzed water, ionized alkaline water or acid water.

12. The cleaning apparatus utilizing nanobubbles according to claim 7, wherein the water comprising nanobubbles further comprises microbubbles.

13. A method for cleaning polluted water by utilizing nanobubbles, which comprises purifying polluted eater with nanobubbles and microbubbles.

14. An apparatus for cleaning polluted water by utilizing nanobubbles, which comprises a device for mixing nanobubbles and microbubbles into polluted water.

15. A method for recovering fatigue of an organism by utilizing nanobubbles, which comprises contacting water comprising nanobubbles with the surface of an organism to thereby recover fatigue of the organism.

16. The method for recovering fatigue of an organism by utilizing nanobubbles according to claim 15, wherein the water comprising nanobubbles further comprises microbubbles.

17. The method for recovering fatigue of an organism by utilizing nanobubbles according to claim 15, wherein a means for contacting the water with the surface of an organism is a bathtub.

18. An apparatus for recovering fatigue of an organism by utilizing nanobubbles, which comprises:
a device for generating nanobubbles within water; and
a means for contacting water comprising nanobubbles with the surface of an organism.

19. The apparatus for recovering fatigue of an organism by utilizing nanobubbles according to claim 18, wherein the water comprising nanobubbles further comprises microbubbles.

20. The apparatus for recovering fatigue of an organism by utilizing nanobubbles according to claim 18, wherein the means for contacting water with the surface of an organism is a bathtub.

21. A method for a chemical reaction utilizing nanobubbles, which comprises carrying out a chemical reaction by utilizing a liquid comprising nanobubbles.

22. The method for a chemical reaction utilizing nanobubbles according to claim 21, wherein the chemical reaction is a nonequilibrium chemical reaction.

23. The method for a chemical reaction utilizing nanobubbles according to claim 21, wherein the nanobubbles act as a catalyst in the chemical reaction.

24. An apparatus for a chemical reaction utilizing nanobubbles, which comprises utilizing a liquid comprising nanobubbles for a chemical reaction.

25. The apparatus for a chemical reaction utilizing nanobubbles according to claim 24, wherein the chemical reaction is a nonequilibrium chemical reaction.

26. The apparatus for a chemical reaction utilizing nanobubbles according to claim 24, wherein the nanobubbles act as a catalyst in the chemical reaction.

27. A method for purification and sterilization utilizing nanobubbles, which comprises utilizing water comprising nanobubbles for purifying and sterilizing a plant.

28. The method for purification and sterilization utilizing nanobubbles according to claim 27, wherein the plant is at least one of vegetables, fruits, crops and foods.

29. An apparatus for purification and sterilization utilizing nanobubbles, which comprises a means for contacting water comprising nanobubbles to a plant to thereby purify and sterilize the plant.

30. The apparatus for purification and sterilization utilizing nanobubbles according to claim 29, wherein the plant is at least one of vegetables, fruits, crops and foods.

31. A method for purification and sterilization utilizing nanobubbles, which comprises purifying and sterilizing water within a pool or a water tank by nanobubbles.

32. An apparatus for purification and sterilization utilizing nanobubbles, which comprises a device for mixing nanobubbles into a pool or a water tank.

33. The method according to claim 1, wherein the nanobubbles are generated at least by application of an ultrasonic wave or by electrolysis.

34. The method according to claim 13, wherein the nanobubbles are generated at least by application of an ultrasonic wave or by electrolysis.

35. The method according to claim 15, wherein the nanobubbles are generated at least by application of an ultrasonic wave or by electrolysis.

36. The method according to claim 21, wherein the nanobubbles are generated at least by application of an ultrasonic wave or by electrolysis.

37. The method according to claim 29, wherein the nanobubbles are generated at least by application of an ultrasonic wave or by electrolysis.

38. The method according to claim 31, wherein the nanobubbles are generated at least by application of an ultrasonic wave or by electrolysis.
